(19) United States
(12) Patent Application Publication
(10) Pub. No.: US 2026/0212564 A1
(43) Pub. Date: Jul. 23, 2026

(54) SYSTEM AND METHODS FOR AUTOMATED CONDITIONAL VISION LANGUAGE MODELS FOROBFUSCATING UNSAFE CONTENT

(71) Applicant: Board of Regents, The University of Texas System, Austin, TX (US)

(72) Inventors: Mazal Bethany, San Antonio, TX (US); Peyman Najafirad, San Antonio, TX (US); Brandon Wherry, San Antonio, TX (US)

(21) Appl. No.: 19/452,359

(22) Filed: Jan. 18, 2026

Related U.S. Application Data
(60) Provisional application No. 63/746,875, filed on Jan. 17, 2025.

(51) Int. Cl. G06T 11/60; G06T 7/11; G06V 10/764; G06V 10/82

(52) U.S. Cl. CPC G06T 11/60; G06T 7/11; G06V 10/764; G06V 10/82

(57) ABSTRACT

The system and method include receiving a visual image; receiving a natural language instruction relevant to the visual image; classifying the visual image as a defined category; generating a conditioned prompt reflecting the natural language instruction and the defined category; processing the visual image through an image encoder-based neural network to generate one or more image feature vectors; transforming the one or more image feature vectors into a vector understandable by a large language model using a Conditional Image Instruction Guide Transformer; outputting an image description based on the natural language instruction; creating an attribution map scoring each pixel in the visual image based on its importance to the defined category; segmenting the image into one or more non-overlapping and mutually exclusive image regions; calculating the importance of each image region based on the attribution map; generating an obfuscated image by obfuscating image regions with high importance.

### RELATED APPLICATION

This application claims the benefit of priority under 35 U.S.C. § 119(e) to U.S. Provisional Ser. No. 63/746,875 , filed on Jan. 17, 2025, the entire contents of which are hereby incorporated by reference.

### FIELD OF INVENTION

This invention relates to a system and method for digital image processing designed to enhance content safety and compliance across various digital domains. The system uniquely identifies, explains the identified content in natural language, and obfuscates unsafe or sensitive regions in images.

### BACKGROUND

Counterfactual reasoning in AI provides a framework for understanding model decisions by considering alternative scenarios. In the context of image processing, counterfactual techniques can identify the minimal changes necessary to alter an image's classification, allowing for more precise and less intrusive content obfuscation. There is a significant need for integrated solutions that can effectively combine advanced image processing with natural language explanations and minimal obfuscation techniques. Such systems are not only essential for online platforms but also for a variety of other domains like public safety, healthcare, and education, where content safety and integrity are of paramount importance. The current landscape presents a unique opportunity for innovation in digital image processing.

### DETAILED DESCRIPTION

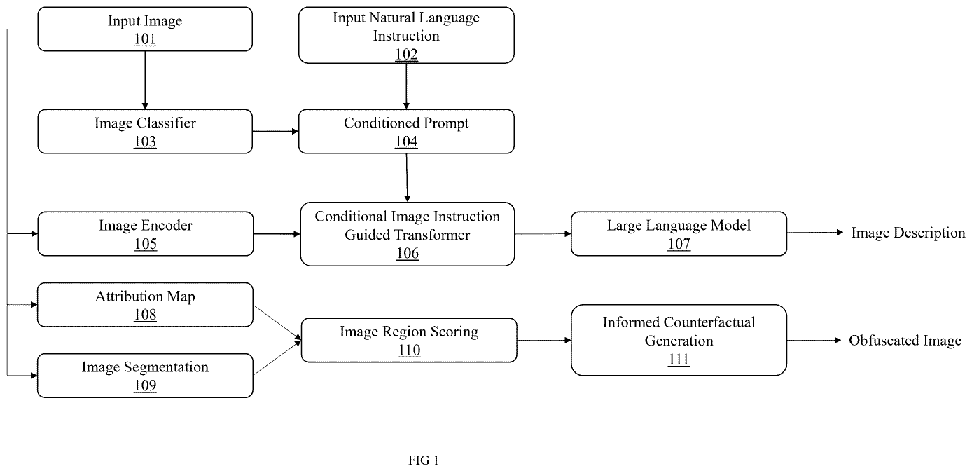

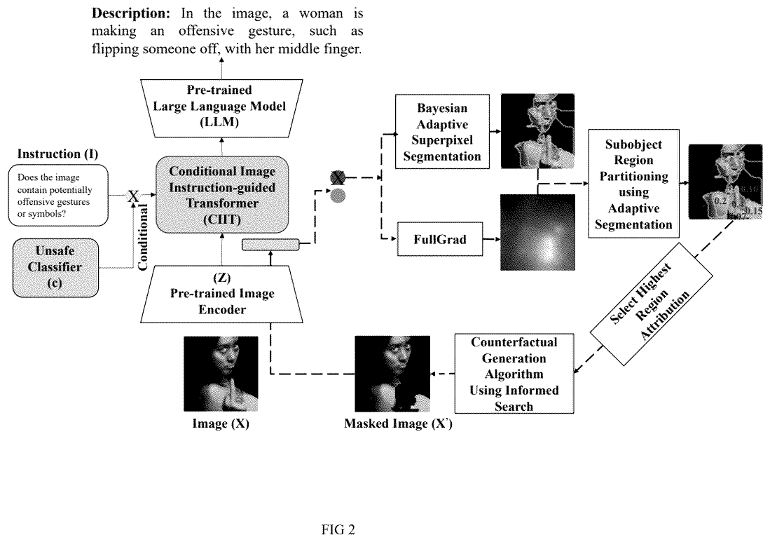

There is a desire for a system that can intelligently identify, explain, and minimally obfuscate unsafe or sensitive content in images, while maintaining overall content integrity, could impact content moderation across multiple industries. FIGS. 1 and 2 illustrate the high-level architecture of the proposed method, where an instruction in natural language and an image is given as input. The image is sent to and analyzed by an image classifier. The analysis is used in conjunction with the instruction in natural language to create a conditioned prompt. Separately, the original image undergoes processing through an image encoder, which extracts its image features. The image features and the conditioned prompt are passed into a conditional image instruction guided transformer. The transformer data is then relayed to a large language model (LLM), which generates a description of the image pertinent to the image classifier's analysis. Simultaneously, the input image is also used to generate an attribution map and to perform image segmentation. The scores from the attribution map are used to create an average score in each segment in the image segmentation. The higher scored regions are used to lead an informed search for a counterfactual analysis to efficiently create an obfuscated image.

To effectively provide relevant descriptions of images, we introduce a framework that synergistically combines the strengths of large language models (LLMs) with the specific requirements of large image encoders, providing more explicit control over visual features. This framework is built upon three key components. The first is a Large Pre-trained Image Encoder, which processes an image to generate a visual embedding representation. The visual embedding representation is compact and serves as an intermediate form of the image data, making it suitable for downstream tasks. This component is exemplified by a state-of-the-art vision transformer, demonstrating its capability in handling complex image data.

The second component, a Conditional Image Instruction-guided Transformer (CIIT), is designed to encode visual data in alignment with specific language prompts. It uniquely leverages contrastive language-image pre-training, enhancing the model's ability to effectively parse and manage various visual embeddings, particularly focusing on controlling features in images deemed unsafe. The transformer decoder in this component plays a crucial role in inverting images based on their instruct prompts, while a generative model learns from the image embeddings. A control code is introduced as a critical element, guiding the CIIT generation process and allowing for a more nuanced decomposition and training of the model.

Third, the framework integrates a Pre-trained Large Language Model Decoder. This component takes text embeddings as input and outputs linguistic sentences, thus bridging the gap between visual and textual data. The decoder has the ability to handle a broad spectrum of complex linguistic tasks.

To effectively obfuscate the image, we aim to connect region attribution to counterfactual sub-object region explanation of an image relative to a given machine learning predictive model. This involves a two-phase approach where the image is first partitioned into non-intersecting sub-object regions. Each sub-object region's attribution value is measured using gradient attribution maps. The next step involves a counterfactual analysis of alternate versions of the image using a greedy search algorithm. This algorithm focuses on regions with the highest attribution values for counterfactual analysis.

In the first phase, sub-object region partitioning is achieved using adaptive segmentation. The given image is divided into a set of non-intersecting regions, defined by super pixels. Super pixels are determined through clustering algorithms that utilize color and spatial information. The goal is to segment the image into meaningful sub-object regions, enabling a counterfactual analysis by the binary predictive model. This requires an adaptive segmentation method, which avoids over-segmentation of uninformative regions while providing detailed segmentation where needed. Techniques like K-means clustering and Gaussian Mixture Models (GMM) are considered for this purpose. GMM is particularly suitable due to its ability to capture the heterogeneity in pixel distribution of different types of images.

The second phase involves sub-object region attribution value determination. For this, the FullGrad attribution map is used for image feature attribution. The goal here is to identify discriminative regions of the image that significantly influence the class prediction score of the predictive model. The attribution map is generated by processing an image through a Convolutional Nural Network (CNN) and combining gradients computed with respect to the input and biases at each layer. This FullGrad attribution map aids in the efficient sampling of regions in the counterfactual analysis. Sub-object region attribution scores are defined based on this map.

However, while these feature attributions highlight significant features, they do not guarantee that altering these features would result in a different desired outcome. Therefore, a measure of confidence reduction for each sub-object region is also considered. This involves calculating the change in the output prediction when a particular sub-object region is masked. Following this, a greedy region search algorithm is employed, which uses sub-object region attribution scores as heuristics and employs confidence levels for causal obfuscation using counterfactual sub-object region explanations. This greedy region search aims to find counterfactual explanations by sorting regions based on their average attribution and iteratively considering subsets of regions until a significant change in prediction is observed.

The present invention has a variety of uses including, but not limited to the following illustrative uses:
Online Content Moderation: The system is exceptionally adept at analyzing and moderating content for digital platforms, ensuring adherence to community standards and regulatory requirements. It can automatically detect and redact sensitive or inappropriate content in real-time, making it invaluable for social media platforms, forums, and other online communities.
Child Safety in Digital Media: In the realm of digital media accessed by children, this invention plays a crucial role in filtering and modifying content to ensure it is age-appropriate and safe. It can be integrated into children's educational apps, games, and online platforms to maintain a secure digital environment.
Corporate Compliance: Corporations can utilize the system to monitor and regulate the digital content within their networks. This is particularly crucial for ensuring compliance with internal policies and external regulatory standards, especially in sensitive industries.
Healthcare and Medical Imaging: The technology can be adapted to enhance the analysis and interpretation of medical images, assisting healthcare professionals in diagnosing and understanding complex medical cases with greater accuracy and efficiency.
Legal and Forensic Analysis: The system's ability to identify and explain specific image regions can be instrumental in legal and forensic settings. It can aid in evidence analysis, helping legal professionals understand and present visual information effectively.
Journalism and Archival Sciences: Journalists and archivists can leverage the system to manage and modify visual content, ensuring that the images they use or archive are compliant with ethical standards and legal requirements.
Automated Redaction for Privacy Protection: The system can be used in scenarios where personal or sensitive information needs to be redacted from images, such as in legal documents, personal identification documents, and in the media, ensuring privacy and compliance with data protection laws.

Embodiments will be described, by way of example only, with reference to the attached figures, wherein in the figures:

FIG. 1 illustrates the high-level architecture of the present system.

FIG. 2 further illustrates the overview of the present architecture, with a single image and natural language illustrating how an image and instruction flow through this architecture.

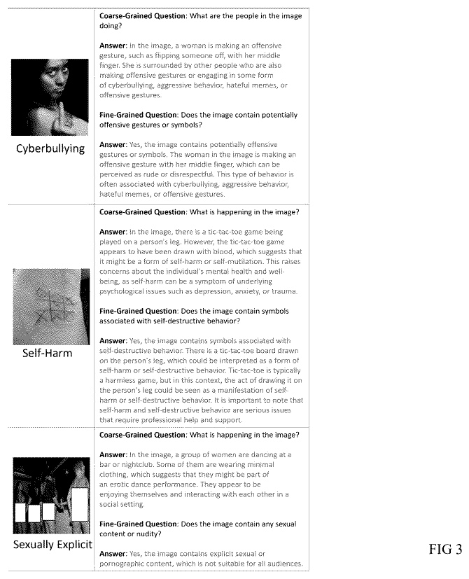

FIG. 3 illustrates some examples of natural language questions asked on images with respect to three content categories often moderated on social media. A coarse-grained question and a fine-grained question are asked on the image to show how our approach is able to effectively answer these questions with respect to the content category in question.

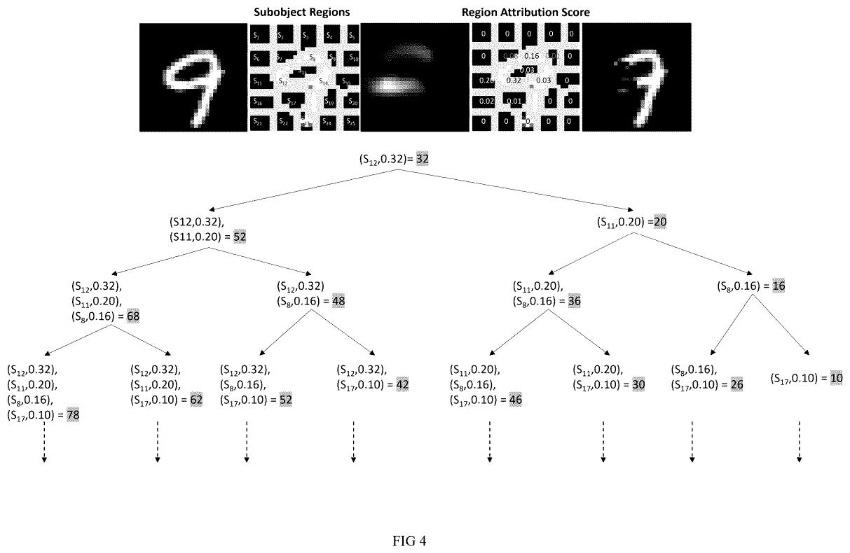

FIG. 4 demonstrates how the informed counterfactual search is performed by creating image regions, scoring these regions with an attribution map and how the informed counterfactual search is performed by first analyzing highly scored regions, leading to a counterfactual image example.

The present disclosure relates to processing an image and natural language instruction through a series of steps to generate a contextually relevant description and an obfuscated image. Firstly, the image is classified and combined with an input natural language instruction to create a conditioned prompt, which, along with image features extracted by an encoder, guides a conditional image instruction-guided transformer connected to a large language model (LLM) for description generation. Concurrently, the image undergoes segmentation and attribution analysis, with high-scoring regions identified for counterfactual analysis to efficiently produce an obfuscated version of the image.

Steps 101 through 111 in FIG. 1 correspond to the overall pipeline of the system for describing and obfuscating the image. Step 101 is a visual image input from any traditional video sources such as webcam, CCTV camera, image files from internet, Internet of Things (IoT) devices, local image files, etc. Step 102 is the input of natural language-based question related to the corresponding input image. In Step 103, a trained neural network classifier classifies an image into one of a number of defined categories. Step 104 is a conditioned prompt that reflects the classification decision of the classifier in Step 103 and the input natural language instruction.

Step 105 is an encoder based neural network which generates a feature vector from the input image. In step 106, the image features and the conditioned prompt are passed into a conditional image instruction guided transformer, which is able to convert an image feature vector into a vector understandable by a large language model (LLM). In step 107, the LLM will output the image description based on the question asked.

Step 108 is an attribution map that scores each pixel in the input image based on its importance to the classification decision. Step 109 is an image segmentation that segments an image into several non-overlapping and mutually exclusive regions. Step 110 is an image region scoring that calculates the importance of each image region based on the attribution map. Step 111 is a counterfactual generation based on the scored image regions where highly scored regions are obfuscated first, resulting in an obfuscated image.

The features of the present invention which are believed to be novel are set forth below with particularity in the appended claims. However, modifications, variations, and changes to the exemplary embodiments of the invention described above will be apparent to those skilled in the art, and the described herein thus encompasses such modifications, variations, and changes and are not limited to the specific embodiments described herein.

What is claimed is:

1. A computer-implemented method for obfuscating unsafe content, comprising:
receiving a visual image;
receiving a natural language instruction relevant to the visual image;
classifying the visual image as a defined category using a trained neural network classifier;
generating a conditioned prompt reflecting the natural language instruction and the defined category generated by the trained neural network classifier;
processing the visual image through an image encoder-based neural network to generate at least one image feature vector;
transforming the at least one image feature vector into a vector understandable by a large language model using a Conditional Image Instruction Guide Transformer;
outputting an image description based on the natural language instruction;
creating an attribution map scoring each pixel in the visual image based on its importance to the defined category generated by the trained neural network classifier;
segmenting the image into a plurality of non-overlapping and mutually exclusive image regions;
calculating the importance of each of the plurality of image regions based on the attribution map;
generating a counterfactual example by obfuscating at least one of the plurality of image regions with high importance; and
generating an obfuscated image.

2. A system for obfuscating unsafe content, comprising:
a processor and a non-transitory computer-readable storage medium storing instructions that, when executed by the processor, cause the processor to perform a method comprising:
receiving a visual image;
receiving a natural language instruction relevant to the visual image;
classifying the visual image as a defined category using a trained neural network classifier;
generating a conditioned prompt reflecting the natural language instruction and the defined category generated by the trained neural network classifier;
processing the visual image through an image encoder-based neural network to generate at least one image feature vector;
transforming the at least one image feature vector into a vector understandable by a large language model using a Conditional Image Instruction Guide Transformer;
outputting an image description based on the natural language instruction;
creating an attribution map scoring each pixel in the visual image based on its importance to the defined category generated by the trained neural network classifier;
segmenting the image into a plurality of non-overlapping and mutually exclusive image regions;
calculating the importance of each of the plurality of image regions based on the attribution map;
generating a counterfactual example by obfuscating at least one of the plurality of image regions with high importance; and
generating an obfuscated image.

3. A computer-implemented system for automatically obfuscating unsafe image content, comprising:
receiving a visual image;
automatically classifying the visual image as a defined category using a trained neural network classifier;
automatically generating a conditioned prompt reflecting the defined category generated by the trained neural network classifier;
automatically processing the visual image through an image encoder-based neural network to generate at least one image feature vector;
automatically transforming the at least one image feature vector into a vector understandable by a large language model using a Conditional Image Instruction Guide Transformer;
automatically outputting an image description of the visual image;
creating an attribution map scoring each pixel in the visual image based on its importance to the defined category generated by the trained neural network classifier;
segmenting the image into a plurality of non-overlapping and mutually exclusive image regions;
calculating the importance of each of the plurality of image regions based on the attribution map; and
automatically generating an obfuscated image by obfuscating at least one of the plurality of image regions with high importance.
